(19) United States
(12) Patent Application Publication
(10) Pub. No.: US 2026/0012099 A1
(43) Pub. Date: Jan. 8, 2026

(54) ON-THE-FLY TOPOLOGY MORPHING FOR FREQUENCY-MULTIPLIER HALF-BRIDGE OPERATION

(71) Applicant: Delta Electronics (Thailand) Public Co., Ltd., Samutprakarn (TH)

(72) Inventors: Philipp REHLAENDER, Paderborn (DE); Roland UNRUH, Paderborn (DE); Frank SCHAFMEISTER, Warburg (DE); Joachim BÖCKER, Berlin (DE)

(21) Appl. No.: 19/325,514

(22) Filed: Sep. 11, 2025

Related U.S. Application Data
(63) Continuation of application No. 17/821,191, filed on Aug. 22, 2022, now Pat. No. 12,456,927.

(30) Foreign Application Priority Data
Aug. 20, 2021 (EP) 21192465.9

(51) Int. Cl. H02M 3/335; H02M 1/08; H02M 3/00

(52) U.S. Cl. CPC H02M 3/33573; H02M 1/08; H02M 3/01

(57) ABSTRACT

Full bridge converter-circuit having a H-bridge, comprising a control circuit for operating the H-bridge in a first operation mode or a second operation mode, wherein the control circuit is configured that between switching from the first operation mode to the second operation mode a morphing operation mode is applied in which a positive inverter voltage pulse length on a first half-bridge of the H-bridge is determined on the basis of a negative inverter voltage pulse length on a second half-bridge of the H-bridge.

### CROSS-REFERENCE TO RELATED DISCLOSURES

This application is a continuation of U.S. application Ser. No. 17/821,191, filed on Aug. 22, 2022, which claims priority to European Application No. 21192465.9,filed on Aug. 20, 2021. The disclosures of the aforementioned applications are hereby incorporated by reference in their entireties.

### TECHNICAL FIELD

The disclosure relates to a full bridge converter-circuit having a H-bridge and a converting method for a full bridge converter-circuit having a H-bridge.

### BACKGROUND

Conventionally, an on-the-fly topology transition with a constant positive voltage pulse length of 50% of the pulse period is used, when switching a full-bridge converter from full-bridge operation to half-bridge operation and reverse. However, during such a transition the magnetizing current may increase dynamically such that the transformer core can be saturated.

Document U.S. Pat. No. 9,263,960 B2 describes an on-the-fly topology morphing modulation to morph from half bridge operating mode to the full bridge operation and reverse. One half bridge is pulsed with a constant duty cycle of 50% whereas the duty cycles of the other half-bridge switches have been adjusted to change from 50% to 0% for one switch. The other switch of the same half bridge is pulsed complimentary.

While this operation is able to reduce oscillations of the output significantly, it can result in partial saturation of the transformer core because the magnetizing current increases dynamically during the morphing process.

### SUMMARY

It is the object of the disclosure to prevent partial saturation of a transformer core due to the magnetizing current that increases dynamically during a morphing process and to achieve a smooth transition from full-bridge mode to frequency multiplier mode and reverse.

The solution of the disclosure is specified by a full bridge converter-circuit.

According to the disclosure the solution is achieved by a full bridge converter-circuit having a H-bridge, comprising a control circuit for operating the H-bridge in a first operation mode or a second operation mode, wherein the control circuit is configured that between switching from the first operation mode to the second operation mode a morphing operation mode is applied in which a positive inverter voltage pulse length on a first half-bridge of the H-bridge is determined on the basis of a negative inverter voltage pulse length on a second half-bridge of the H-bridge. The positive inverter voltage pulse length can be equal to the switching time for switching a switch on the first half-bridge of the H-bridge. The negative inverter voltage pulse length can be equal to the switching time for switching a switch on the second half-bridge of the H-bridge. By dynamically adjusting the length of the positive inverter voltage pulses, a dynamic increase of the magnetizing current can be effectively limited to prevent transformer saturation.

In a preferred embodiment of the full bridge converter-circuit the first operation mode is a full bridge operation of the H-bridge and the second operation mode is a frequency multiplier half bridge operation of the H-bridge where the switches are pulsed with a switching frequency that is at least twice the frequency of the resonant current or the first operation mode is a frequency multiplier half bridge operation of the H-bridge and the second operation mode is a full bridge operation of the H-bridge. This yields the technical benefit that the voltage-transfer ratio of the full bridge converter-circuit can be increased. Thermal imbalances are reduced or remain the same as with conventional half-bridge modulation resulting in lower junction temperatures.

In a further preferred embodiment of the full bridge converter-circuit the control circuit is configured to increase or decrease the negative inverter voltage pulse length linearly during the morphing operation mode. Increasing or decreasing can be performed with an up-down counter to achieve the pulse pattern. Linear decreasing of the second duty cycle can be performed from 0.5 to 0 over time and linear increasing of the second duty cycle can be performed from 0 to 0.5 over time. This yields the technical benefit that a smooth morphing operation from one operation mode to the other is achieved.

In a further preferred embodiment of the full bridge converter-circuit the full bridge converter-circuit comprises a look up table for looking up the positive inverter voltage pulse length on the basis of the negative inverter voltage pulse length. This yields the technical benefit that values of the first duty cycle can be determined fast and reliably.

In a further preferred embodiment of the full bridge converter-circuit the positive inverter voltage pulse length is adjusted based on the measurements of a magnetic field sensor or the positive inverter voltage pulse length is adjusted based on online calculations. This yields the technical benefit that an even better adjusting result can be achieved.

In a further preferred embodiment of the full bridge converter-circuit the look up table is stored in a digital memory of the control circuit. The digital memory can be a random access memory (RAM) or a read only memory (ROM). This yields the technical benefit that the control circuit has quick access to the value of the first duty cycle.

In a further preferred embodiment of the full bridge converter-circuit a functional graph representing the dependency of the positive inverter voltage pulse length on the negative inverter voltage pulse length has a minimum. This yields the technical benefit that the magnetizing current can be reduced effectively.

In a further preferred embodiment of the full bridge converter-circuit the minimum is between a value of 0.2 and 0.3 of the negative inverter voltage pulse length and/or between a value of 0.2 and 0.3 of the positive inverter voltage pulse length. This yields the technical benefit that the magnetizing current can be reduced even more effectively.

In a further preferred embodiment of the full bridge converter-circuit the functional graph is V-shaped. This also yields the technical benefit that the magnetizing current can be reduced effectively.

In a further preferred embodiment of the full bridge converter-circuit to the value of 0 of the negative inverter voltage pulse length a value of 0.5 of the positive inverter voltage pulse length is assigned and/or to the value of 0.5 of the negative inverter voltage pulse length a value of 0.5 of the positive inverter voltage pulse length is assigned. This yields the technical benefit that the dynamic increase of the magnetization current can be reduced to a large extend.

In a further preferred embodiment of the full bridge converter-circuit the full bridge converter-circuit is an LLC resonant converter. This yields the technical benefit that an appropriate circuit is applied.

According to the disclosure the solution is also achieved by a converting method for a full bridge converter-circuit having a H-bridge, comprising the steps of operating the H-bridge in a first operation mode; operating the H-bridge in a morphing operation mode in which a positive inverter voltage pulse length on a first half-bridge of the H-bridge is determined on the basis of a negative inverter voltage pulse length on a second half-bridge of the H-bridge; and operating the H-bridge in a second operation mode. By this converting method same technical benefits can be achieved as with the aforementioned full bridge converter-circuit.

In a preferred embodiment of the converting method the negative inverter voltage pulse length is increased or decreased linearly during the morphing operation mode. This also yields the technical benefit that a smooth morphing operation from one operation mode to the other is achieved.

In a further preferred embodiment of the converting method the positive inverter voltage pulse length is stored in a look up table on the basis of the negative inverter voltage pulse length. This also yields the technical benefit that values of the first duty cycle can be determined fast and reliably.

In a further preferred embodiment of the converting method the look up table is stored in a digital memory of the control circuit. This also yields the technical benefit that the control circuit has quick access to the value of first duty cycle.

In a further preferred embodiment of the converting method the look up table is derived from simulations in which a pulse length is adjusted to control the magnetizing current.

This yields the technical benefit that an optimum relationship between the first duty cycle and the second duty cycle can be determined.

Other advantageous embodiments and combinations of features come out from the detailed description below and the entirety of the claims.

### BRIEF DESCRIPTION OF DRAWINGS

The drawings used to explain the embodiments show:

FIG. 1 is a circuit diagram of an LLC resonant converter.

FIG. 2A to FIG. 2D are four possible half bridge modulations for an LLC resonant converter.

FIG. 3A and FIG. 3B are frequency multiplied half bridge modulations employed on the LLC converter.

FIG. 4 is a loss analysis assuming a constant on-state resistance.

FIG. 5A and FIG. 5B are experimental measurement results of the frequency multiplied half bridge modulation.

FIG. 6A and FIG. 6B are half-bridge configuration with half bridge modulations and frequency multiplied half bridge modulation.

FIG. 7A to FIG. 7C are on-the-fly morphing transition from full-bridge modulation to half-bridge configuration.

FIG. 8A and FIG. 8B are experimental measurement results of an alternating asymmetrical morphing transition.

FIG. 9A to FIG. 9C are experimental measurement results of a symmetrical morphing transition.

FIG. 10 is an improved morphing operation from full-bridge to FD-HBM.

FIG. 11 is a functional graph representing the dependency of duty cycles.

FIG. 12 is a conventional morphing transition with a constant duty cycle.

FIG. 13 is an improved morphing transition with a dynamic duty cycle.

FIG. 14 is a block diagram of a converting method.

In the figures, the same components are given the same reference symbols.

### DESCRIPTION OF EMBODIMENTS

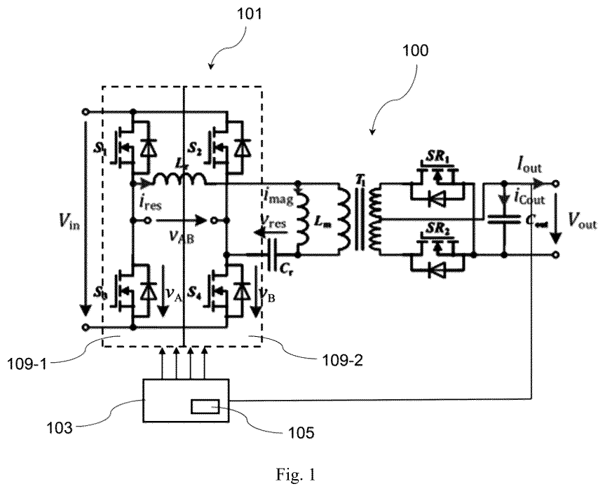

FIG. 1 shows a circuit diagram of an LLC resonant converter as a full bridge converter-circuit 100 having an H-Bridge 101. The H-Bridge 101 comprises a first half bridge 109-1 having the switches S₁ and S₃ and a second half bridge 109-2 having the switches S₂ and S₄. A control circuit 103 serves for controlling each of the switches S₁, S₂, S₃ and S₄.

The switches S₁, S₂, S₃ and S₄ are implemented by suitable Metal-Oxide-Semiconductor Field-Effect Transistors (MOSFET).

Conventional LLC converters are not suitable for a wide voltage-transfer ratio as it results in a wide switching frequency range. To ensure a sufficient gain, the inductance ratio Lᵣ/Lₘ needs to be designed small leading to large resonant currents that have a detrimental effect on the efficiency. Therefore, the LLC resonant converter is best applied near resonance. However, to cover a wide voltage-transfer ratio, an LLC full-bridge converter can be operated in half-bridge operation mode instead to a full bridge operation mode. In this case one of the switches S₁, S₂, S₃ and S₄ is turned on continuously, whereas the other corresponding switch S₁, S₂, S₃ and S₄ of the respective bridge leg is permanently turned off. This, however, leads to large conduction losses of the permanently turned-on switch (no switching losses) while the switch that is turned off exhibits no losses. Each switch S₁, S₂, S₃ and S₄ that is pulsed, on the other hand, exhibits half the conduction losses of the switch S₁, S₂, S₃ and S₄ that is permanently turned on and additional switching losses.

The full-bridge converter 100 with a blocking capacitor in the resonant path is operated in half-bridge mode to decrease the gain of this specific mode and, thus, increase the gain range of the converter. While in the conventional full-bridge operation the inverter voltage is pulsed between ν_{AB} ε{−Vᵢₙ; +Vᵢₙ}, in half-bridge operation mode the inverter voltage is pulsed between ν_{AB} ε{−Vᵢₙ; 0} or ν_{AB} ε{0; Vᵢₙ}. The resonant capacitor Cr hereby acts as a blocking capacitor as the average voltage is half the input voltage. As the blocking capacitor is charged to half the input voltage, the effective input voltage of the transformer is reduced by a factor of two. This reduces the gain by a factor of two making this operation mode especially useful for small voltage-transfer ratios whereas for large voltage-transfer ratios the conventional full-bridge operation can be employed.

For intermediate gains and loads, phase-shift operation is beneficial to reduce the switching frequency and increase the efficiency. To change the operation mode from full-bridge operation to half-bridge operation and reverse, an on-the-fly topology morphing operation mode is applied between switching from the one mode to the other.

If the LLC converter 100 is operated in half-bridge operation mode, one switch S₁, S₂, S₃ and S₄ conducts the full resonant current while exhibiting no switching losses. The respective other switch S₁, S₂, S₃ and S₄ of this half-bridge 109-1 or 109-2 is permanently turned off such that this switch is not stressed at all. The switches S₁, S₂, S₃ and S₄ of the pulsing half bridge 109-1 or 109-2 conduct the resonant current for one half of a period such that they are stressed with half the conduction losses compared to the switch S₁, S₂, S₃ and S₄ that is permanently turned on. However, they exhibit turn-off losses.

This leads to imbalanced inverter losses. For dominant conduction losses, the switch that is permanently turned on is stressed with much larger losses than the pulsing switch.

If the switching losses are dominant, the pulsing switches S₁, S₂, S₃ and S₄ exhibit larger losses compared to the switch S₁, S₂, S₃ and S₄ that is permanently turned on.

The frequency-multiplier modulation (FMM) is a beneficial alternative to the conventional half-bridge modulation (HBM) to reduce the maximum junction temperature. While both half bridges 109-1 or 109-2 are pulsed with half the operating frequency, the resulting inverter voltage has a multiple integer of the frequency of the half bridges 109-1 or 109-2. The FMM can be applied for the conventional full-bridge LLC converter 100. As this modulation emulates the HBM it will be referred to as frequency-multiplier half-bridge modulation (frequency-multiplier half-bridge modulation, FM-HBM). This modulation is an alternative to the conventional HBM.

By employing the FM-HBM, the maximum junction temperature can be reduced significantly and should be the preferred modulation when employing half-bridge configuration. Furthermore, a simple-to-implement modulation is used to morph in operation on-the-fly from full-bridge to FM-HBM and back.

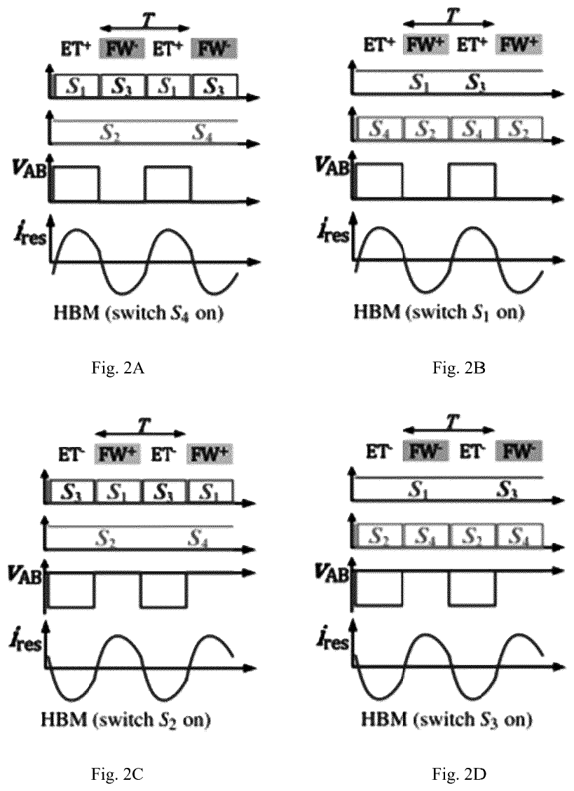

FIG. 2A to 2D show four possible HBMs for an LLC resonant converter 100. The switches S₁, S₂, S₃ and S₄ of a full-bridge inverter are switched to achieve four different switching states: in two energy-transfer (ET) states energy may be transferred from the input to the resonant tank or the output. In the other two freewheeling (FW) states, the inverter voltage is zero such that no energy is transferred from the input to the resonant tank or the output. The following list shows all of the four switching states with the appropriate switches that are turned on:

$$\begin{matrix}\cdot ET + : {S}_{1} and {S}_{4} \to {v}_{A B} = {V}_{in} \\ \cdot ET - : {S}_{2} and {S}_{3} \to vAB = - Vin \\ \cdot FW + : {S}_{1} and {S}_{2} \to v A B = 0 \\ \cdot FW - : {S}_{3} and {S}_{2} \to v A B = 0\end{matrix}$$

When employing the conventional HBM, one leg of the inverter is not pulsed-one switch is permanently turned on while the other switch is permanently turned off. All potential HBM schemes are depicted in FIG. 2A to FIG. 2D. Intervals with ν_{AB}=0 are depicted in blue for FW⁺-intervals and in red for FW⁻-intervals.

FIG. 2A and FIG. 2B show modulations that result in a positive (or zero) inverter voltage (the average resonant capacitor voltage is

$${v}_{res} = \frac{1}{2} {V}_{in} ) ,$$

whereas FIG. 2C and FIG. 2D show modulations that result in only negative (or zero) inverter voltages (the average resonant capacitor voltage is

$${v}_{res} = \frac{1}{2} {V}_{in} ) .$$

Modulations in FIG. 2B and FIG. 2C cannot be achieved with bootstrap drivers since the high-side switches cannot be permanently turned on with this driver supply. The modulations in FIG.2A and FIG. 2B as well as modulations in FIG. 2C and FIG. 2D result in an equal inverter output voltage VAB and, thus, in equal resonant currents. Assuming that MOSFETs are employed as the inverter switches S₁, S₂, S₃ and S₄, the losses of the individual switches S₁, S₂, S₃ and S₄ that are pulsed can be calculated as:

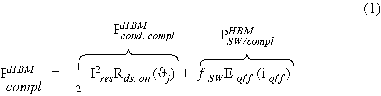

To evaluate the distribution of the losses, the losses of these switches S₁, S₂, S₃ and S₄ are divided into the conduction losses

$${P}_{cond , compl}^{HBM}$$

and the switching losses

$${P}_{sw , compl}^{HBM} .$$

The switch S₁, S₂, S₃ and S₄ that is permantly turned on is stressed with the full resonant current such that the losses can be calculated as:

$${P}_{p - on}^{HBM} = {I}_{res}^{2} - {R}_{ds , on} ( {ϑ}_{j} ) \qquad ( 2 )$$

Assuming that the same MOSFET type is employed for all switches S₁, S₂, S₃ and S₄ and neglecting temperature dependencies of the on-state resistance R_{ds,on}, the overall inverter losses can be calculated as

$${P}_{inv} = 2 {I}_{res}^{2} {R}_{ds , on} + 2 {f}_{sw} {E}_{off} ( {i}_{off} ) .$$

The conduction losses of the switch S₁, S₂, S₃ and S₄ that is permanently turned on are twice as large as the conduction losses of the pulsed switches S₁, S₂, S₃ and S₄

$$( {P}_{p - on}^{HBM} = 2 {P}_{cond , compl}^{HBM} ) .$$

This may be a problem for converters that employ switches where conduction losses are the dominant loss contributor—in this case the switches S₁, S₂, S₃ and S₄ are designed for a lower on-state resistance, which results in larger conversion costs.

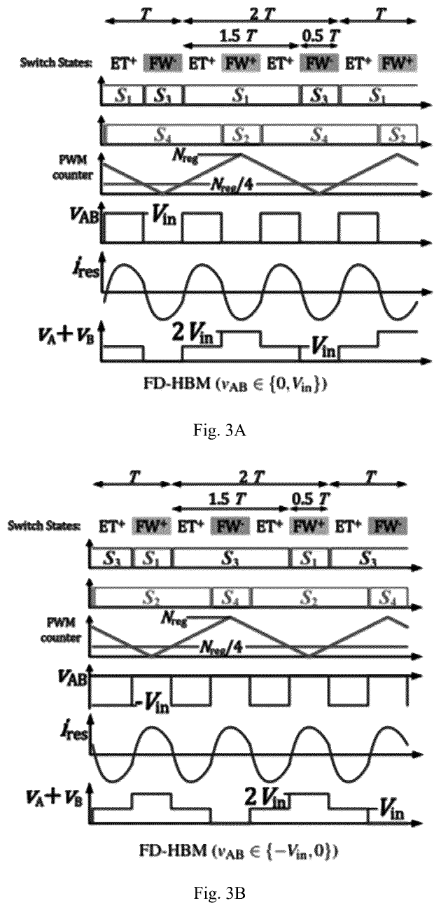

From the afore described FIG. 2 it is evident that two modulations achieve exactly the same inverter voltage. Therefore, it is possible to interchange the freewheeling intervals FW⁺ and FW⁻ as depicted in FIG. 3A and FIG. 3B without modifying the inverter voltage ν_{AB}. By including both FW⁺ and FW⁻ intervals into the modulation, the switching frequency of S₁ and S₂ reduces while the operating frequency of the LLC remains the same. The operating frequency is, thus, multiplied compared to the switching frequency of the individual switches. Therefore, these modulations10 are labeled frequency-multiplier modulation or frequency-multiplier half-bridge modulation.

FIG. 3A and FIG. 3B show a frequency-doubler half-bridge modulation FD-HBM with a switching frequency of half the operating frequency. The FD-HBM is a specific example of the FM-HBM that is employed on the LLC converter 100.

The modulation consists of intervals of the length 3 T/2 and T/2, which are phase shifted for one bridge leg by T. The pulses of the switches S₁, S₂, S₃ and S₄ thus repeat their pattern every 2T.

Employing this concept, asymmetrical pulse patterns result for both half bridges 109-1 and 109-2, which are phase-shifted by T. Considering FIG. 3A and FIG.

3B, the modulation utilizes an up-down counter to achieve the pulse pattern. It is equally possible to employ any other counter. However, an up-down counter is beneficial in an on-the-fly morphing operation and is also employed to achieve balanced losses for an operation in phase-shift mode. This avoids the necessity of a PWM reconfiguration.

Two distinct types of switches S₁, S₂, S₃ and S₄ can be distinguished: the switches that are turned on 75% of the time, resulting in high losses and the switches that are turned on for the remaining 25% of the time, resulting in lower losses. The high losses

$${P}_{high}^{FD - HBM}$$

of the switches that are turned on 75% of the time can be calculated as

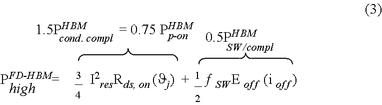

The overbrace puts these losses in relation to the conventional HBM while neglecting temperature dependencies of the on-state resistance. The switches are turned off every two periods T of the resonant current while the switches conduct for three quarters of a period. The lower losses

$${P}_{low}^{FD - HBM}$$

of the switches that are only turned on for 25% of the time on the other hand can be calculated as

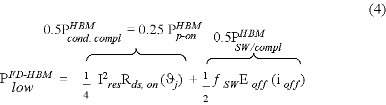

Thus, the overall losses Pᵢₙᵥ of this modulation are the same compared to the conventional HBM. To evaluate the performance of this modulation, the HBM and the FM-HBM are evaluated for different loss distributions of the conduction losses and the switching losses. The reference is the conventional HBM.

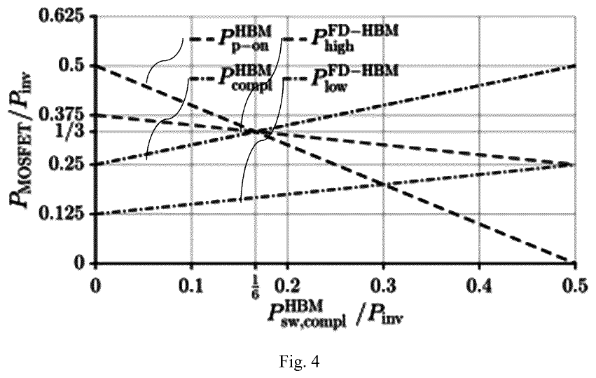

FIG. 4 shows a loss analysis assuming a constant on-state resistance R_{ds,on}. The losses of the switches S₁, S₂, S₃ and S₄ are depicted over the ratio of the switching losses

$${P}_{sw , compl}^{HBM}$$

to the overall losses of the operation Pᵢₙᵥ. Obviously, the FM-HBM distributes the losses more equally among all switches S₁, S₂, S₃ and S₄ compared to the conventional HBM. While for

$${P}_{sw , compl}^{HBM} / {P}_{inv} < 1 / 6$$

dominant conduction losses in

$${P}_{compl}^{HBM} ) ,$$

the switch that is permanently turned on experiences the largest losses, for

$${P}_{sw , compl}^{HBM} / {P}_{inv} < 1 / 6$$

(dominant switching losses in

$${P}_{compl}^{HBM} ) ,$$

the switches that are switched face the largest losses.

The switch S₁, S₂, S₃ or S₄ being subject to the largest losses of the FM-HBM

$${P}_{high}^{FD - HBM}$$

always shows lower or identical overall losses than the most-stressed switch S₁, S₂, S₃ and S₄ of the conventional HBM. Only for

$${P}_{sw , compl}^{HBM} / {P}_{inv} < 1 / 6 ,$$

where the conduction and switching losses are equal in

$${P}_{compl}^{HBM} ( {P}_{sw , compl}^{HBM} = {P}_{cond , compl}^{HBM} ) ,$$

the losses of the maximum stressed switches S₁, S₂, S₃ or S₄ in the HBM are the same as the maximum stressed switches S₁, S₂, S₃ or S₄ in the FM-HBM. The HBM and FM-HBM can for example be both employed on an LLC converter 100 utilizing silicon-carbide (SiC) MOSFETs of type SCT3120AW7 (Rohm, 650 V, 120 mΩ @ 25° C.) in the operating point Vᵢₙ=350 V, Vₒᵤₜ=11.5 and Iₒᵤₜ=125 A.

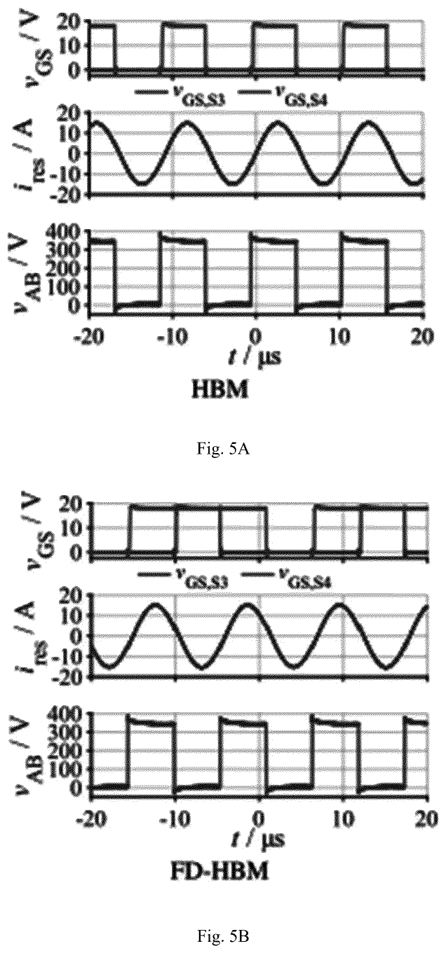

FIG. 5A and 5B shows experimental measurement results of the HBM and

FM-HBM. Depicted are the low-side gate voltages νv_{GS,S3} and ν_{GS,S4}, the resonant current iᵣₑₛ and the inverter voltage ν_{AB}. Both modulations result in about equal inverter voltages and resonant currents. The measured efficiencies are identical.

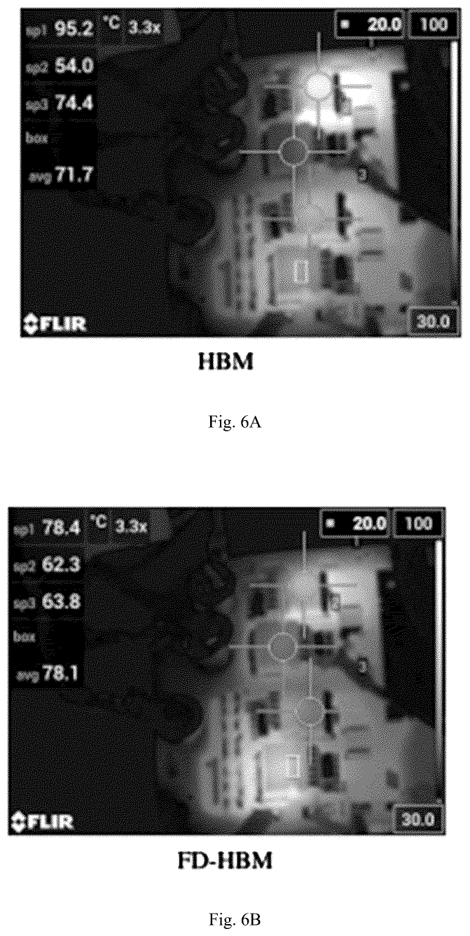

FIG. 6A shows an LLC half-bridge configuration with HBM and FIG. 6B shows a FM-HBM in a thermal analysis. FIG. 6A depicts the modulation of FIG. 2B, while FIG. 6B depicts the modulation of FIG. 3A. From top to bottom the switches (shown by the marker) are: S₁, S₂, S₃ and S₄. The FM-HBM reduces the maximum temperature by about 17 K. For the depicted operation, conduction losses are the dominant loss contributor. The results are at thermal steady state at the same operating conditions.

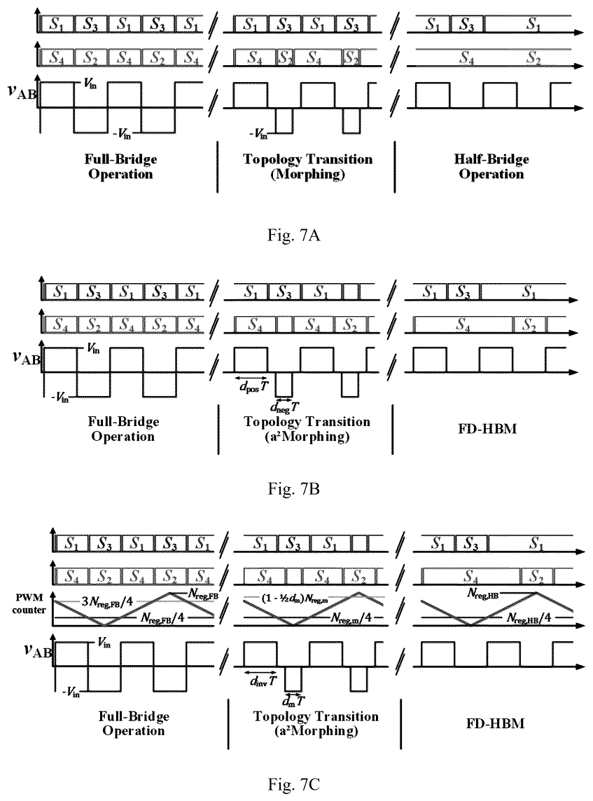

FIG. 7A to FIG. 7C show an on-the-fly morphing transition full-bridge to half-bridge mode and back. FIG. 7A shows a transition to the conventional half-bridge configuration and FIG. 7B a transition to the FM-HBM. For FIG. 7B, one compare value is shifted to achieve the morphing modulation. FIG. 7C includes the triangle modulation for determining the duty cycles.

To change the operating mode from full-bridge to half-bridge mode and back, an intermediate on-the-fly topology morphing method is used. For this transition, the lowside duty cycle of one half-bridge is slowly increased from 50% to 100% whereas the high-side switch of the respective half bridge 109-1 and 109-2 is switched complimentary. For a transition from half-bridge to full-bridge operation, this method is reversed.

While the duty cycle of all switches changes only by 25% when transitioning between the full-bridge modulation and the FM-HBM, the average resonant capacitor voltage is adjusted from ν̅ᵣₑₛ=0 to ν̅ᵣₑₛ=Vᵢₙᵥ/2 (or to ν̅ᵣₑₛ=−Vᵢₙᵥ/2 if the other half-bridge configuration is employed). The sudden change from half-bridge configuration to full bridge configuration results in current or voltage breakdowns or overshoots. Considering the change of the switching frequency and resonant capacitor voltage a large overshoot/undershoot of the (photovoltaic) voltage and current is observed. A sudden transition from full-bridge to FM-HBM and back leads to an output voltage overshoot of 44% when transitioning from FM-HBM to full-bridge modulation and to an undershoot of 36% in the reverse direction. A feed-forward control adjusting the switching frequency is able to reduce this over-/undershoot.

However, since the switching frequency depends on the components of the resonant tank, component deviations affect the system behavior such that this type of control may be problematic if the exact component values are not matched. Furthermore, the switching frequency depends on the output load, which requires that the load must be known at the instance of the transition.

Employing the FM-HBM, it is equally possible to control the morphing

from full-bridge to FM-HBM modulation and back (visualized for the Frequency Multiplier operation in FIG. 7B. The operation is hereby achieved also with an up-down counter. During the morphing operation mode one of the reference values is slowly adjusted to achieve the morphing modulation while the frequency is adjusted to achieve a steady output voltage/current. Since the modulation does not alter the shape of the inverter voltage, the traits of the morphing modulation remain the same: the magnetizing current still needs to be addressed in the design process and may still increase dynamically during the morphing transition. Furthermore, similar to the conventional morphing method, this modulation also results in a hard turn-on of the switches S₁, S₂, S₃ or S₄ close to the FMHBM.

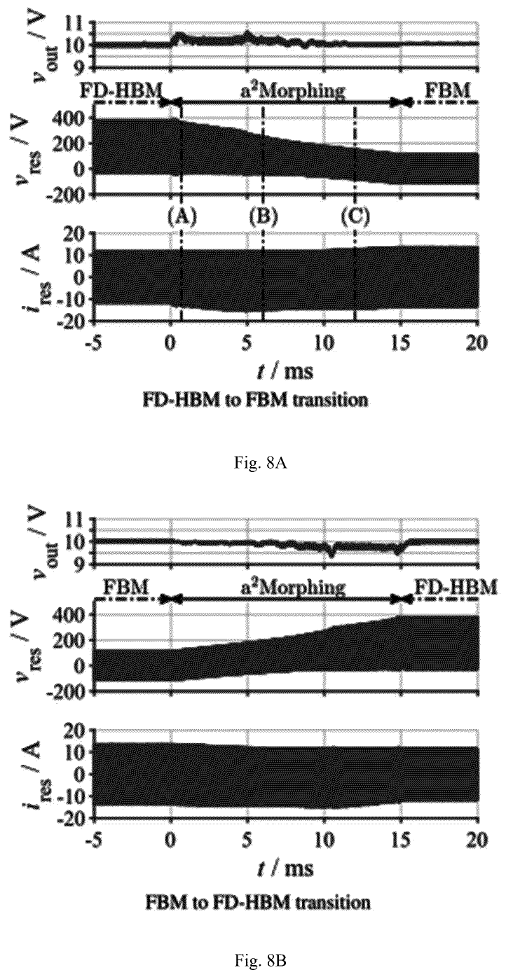

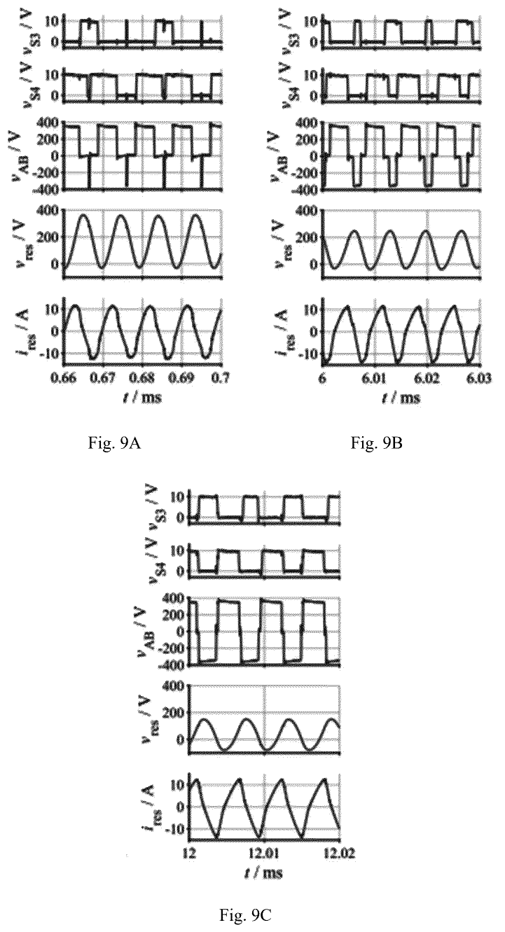

FIG. 8A and FIG. 8B show experimental measurement results of the alternating asymmetrical (a2) morphing transition. FIG. 8A shows a transition from FD-HBM as an example of the FM-HBM to FBM, the intersections (A)-(C) show the intervals that are depicted in FIG. 9A to FIG. 9C. FIG. 8B shows a transition from

FBM to FM-HBM. The alternating asymmetrical (a2) morphing as depicted in FIG. 7B in both directions can be implemented on an LLC converter 100 for the operating point Vᵢₙ=350 V, Vₒᵤₜ=10 V and Iₒᵤₜ=100 A. The transition results in an output voltage (Vₒᵤₜ) over/undershoot of about 6%.

FIG. 9A to FIG. 9C show experimental measurement results of the a2 morphing transition. Different time intervals of the transition process in FIG. 8A are depicted in FIG. 9A to FIG. 9C. The gate voltages νₛ₃ and νₛ₄, the inverter voltage ν_{AB} and the resonant voltage νᵣₑₛ and current iᵣₑₛ at different times in the FM-HBM to full-bridge transition of FIG. 8B are visualized.

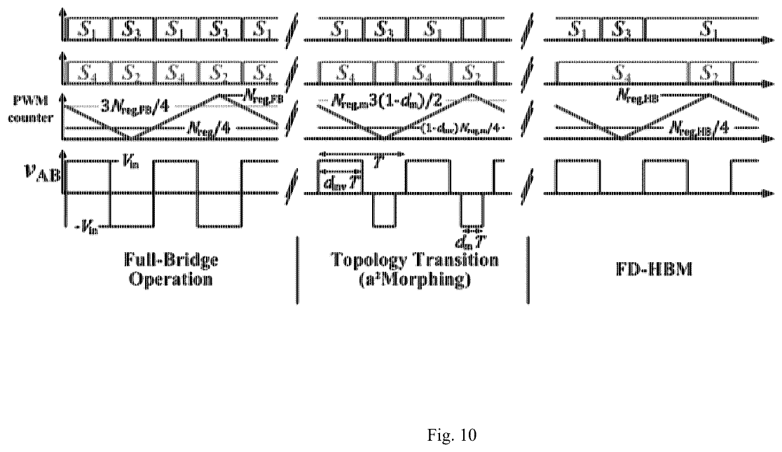

FIG. 10 shows an improved morphing operation from full-bridge to

FD-HBM. The inverter voltage can, however, be equally transferred to the conventional morphing process. In his morphing operation mode, the positive inverter voltage pulse length dₚₒₛ*T on the first half-bridge 109-1 of the H-bridge 101 is determined on the basis of the negative inverter voltage pulse length d_{neg}*T on the second half-bridge 109-2 of the H-bridge 101.

The positive inverter voltage pulse length dₚₒₛ*T can be equal to the switching time dᵢₙᵥ*T for switching a switch S₁, S₃ on the first half-bridge of the H-bridge, where dᵢₙᵥ is the duty cycle and T the time length of the switching period. The negative inverter voltage pulse length d_{neg}*T can be equal to the switching time dₘₒᵣₚₕ*T for switching a switch S₂, S₄ on the second half-bridge of the H-bridge, where dₘₒᵣₚₕ is the duty cycle and T the time length of the switching period.

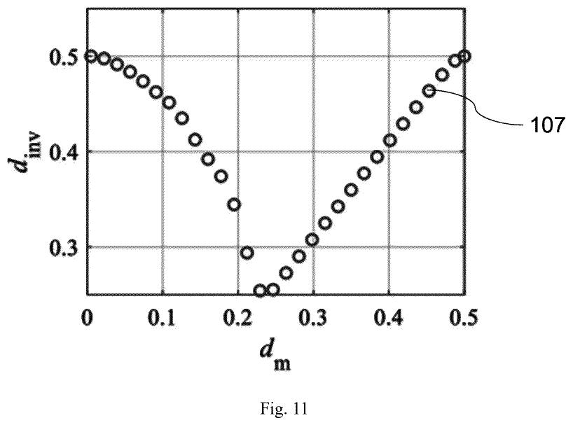

This morphing operation mode differs from the above in that the constant duty cycle dᵢₙᵥ is replaced by a dynamic duty cycle dᵢₙᵥ the value of which is dependent on the value of the duty cycle dₘ. In this morphing operation mode, the magnetizing current can be effectively limited to prevent a saturation of the transformer. The relationship between the duty cycle dᵢₙᵥ and duty cycle dₘ can be stored in a lookup table (LUT). The lookup table can be stored in a digital memory 105 of the control circuit 103. The lookup table can be derived using simulation results where a controller adjusts the pulse length to control the magnetizing current. FIG. 11 shows a functional graph 107 representing the dependency of the

duty cycle dᵢₙᵥ on the second duty cycle dₘ. The functional graph 107 is stored as discrete values in the lookup table. The functional graph 107 is obtained for the resonant tank parameters Lᵣ=30 μH, Lₘ=200 μH and Cᵣ=90 nF. The functional graph 107 is V-shaped and has a minimum between a value of 0.2 and 0.3 of the duty cycle dₘ and between a value of 0.2 and 0.3 of the first duty cycle dᵢₙᵥ.

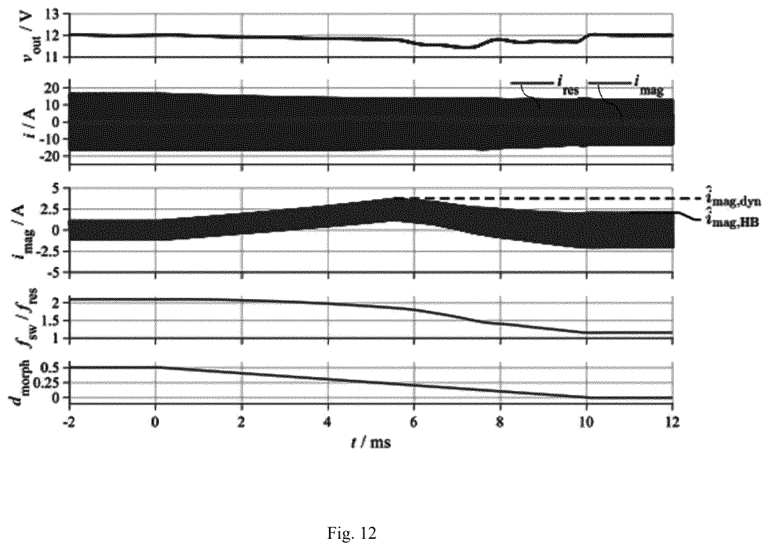

FIG. 12 shows a conventional morphing transition with a constant duty cycle. The on-the-fly topology transition is achieved with a constant positive voltage pulse length of tᵢₙᵥ=0.5 T, where T is the pulse period. During the transition, the magnetizing current may increase dynamically such that the transformer core can be saturated. The magnetizing current increases dynamically by 70% compared to the steady-state value.

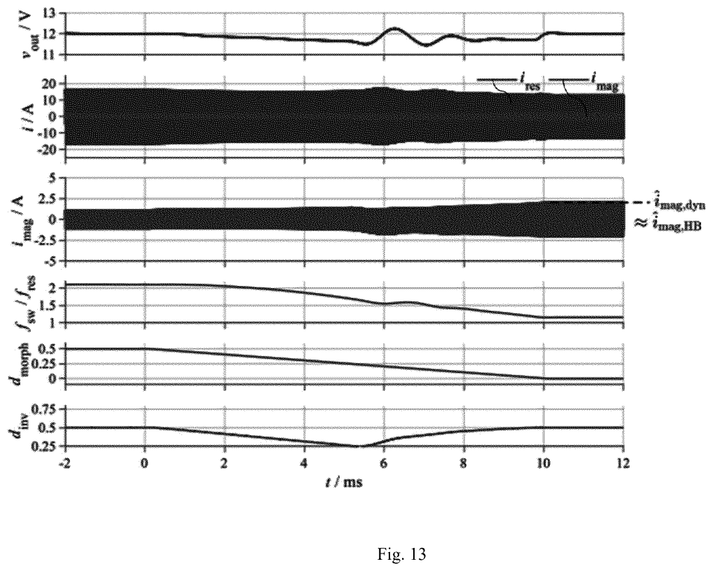

FIG. 13 shows the improved morphing transition with a dynamic duty cycle. The duty cycle dᵢₙᵥ is dynamically adjusted according to the lookup table as depicted in FIG. 11. The magnetizing current does not increase dynamically and stays below the steady-state maximum. Thus, by adjusting the positive inverter voltage pulse, the dynamic increase of the magnetizing current can be limited to prevent transformer saturation.

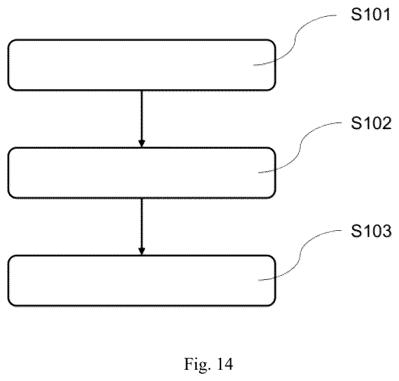

FIG. 14 shows a block diagram of a converting method for the full bridge converter-circuit 100. The converting method comprises the step S101 of operating the H-bridge 101 in the first operation mode. In step S102 the H-bridge 101 is operated in a morphing operation mode in which the positive inverter voltage pulse length dₚₒₛ*T on the first half-bridge 109-1 of the H-bridge 101 is determined on the basis of the negative inverter voltage pulse length d_{neg}*T on the second half-bridge 109-2 of the H-20 bridge 101. In step S103 the H-bridge 101 is operated in a second operation mode.

The positive inverter voltage pulse length dₚₒₛ*T and/or the negative inverter voltage pulse length d_{neg}*T are adapted such that the duty cycle dpos equals to the duty cycle dᵢₙᵥ and the duty cycle d_{neg} equals to the duty cycle dₘ.

By employing the frequency-multiplier half-bridge modulation (FM-HBM), the junction temperature of the most-stressed inverter switch can be reduced significantly compared to the conventional HBM. The benefit depends on the system configuration and operating point. While for dominant conduction or switching losses, the benefit is remarkable, for nearly identical switching and conduction losses of the complementary switched MOSFETs, the junction temperature is similar. To maximally exploit the primary semiconductors in half-bridge configuration, the FM-HBM is the superior choice compared to the conventional HBM. Especially if conduction losses are the dominant loss contributor and the semiconductors are designed for full-bridge configuration, the FM-HBM offers an easy and effective loss reduction of the most stressed semiconductor.

An on-the-fly morphing transition between FM-HBM and full-bridge

operation can be easily achieved using an up-down counter for the modulation. Experimental results prove that the undershoot/overshoot of the transition was limited to only 6%. Finally, EMI implications of the modulation must be considered as additional noise frequencies that result from the reduced switching frequency at odd integers of half the operating frequency. While this operation was able to reduce oscillations of the output significantly, it can result in partial saturation of the transformer core because the magnetizing current increases dynamically during the morphing process.

Through the frequency-multiplier modulation over at least two resonant periods, thermal imbalances are reduced or remain the same as with conventional half-bridge modulation, resulting in lower junction temperatures. If the operating mode, however, is changed suddenly from full-bridge operation to frequency multiplier modulation during the operation, the output voltage may experience significant oscillations that can destroy the converter. Through the presented easy-to-implement on-the-fly topology morphing, it is possible to morph during the operation from full-bridge modulation to frequency-multiplier half-bridge operation and reverse. During the morphing process, it is possible to slowly adjust the frequency to prevent significant output oscillations. By controlling the pulse lengths during the morphing mode operation, saturation of the transformer core is prevented and a constant output power during the morphing is maintained.

In summary, it is to be noted that the disclosure enables to provide a method as well as a circuit for limiting a dynamic increase of the magnetizing current to prevent transformer saturation.

What is claimed is:

1. A full bridge converter-circuit, comprising:
a resonant tank and an H bridge having two half bridges, each of the half bridges comprises a pair of switches;
a control circuit configured to operate the H-bridge in one of a first operation mode, a second operation mode, and a third transition mode between the first operation mode and the second operation mode,
wherein the first operation mode is operated with a first switching frequency, a first duty cycle, and a first switching period, the second operation mode is operated with a second switching frequency, a second duty cycle and a second switching period, and the third transition mode is operated with a first dynamic duty cycle for a first half bridge, a second dynamic duty cycle for a second half bridges and a morphing frequency varying gradually between the first switching frequency and the second switching frequency;
wherein the control circuit is configured to, in the third transition mode, determine pulse patterns of the H bridge according to a PWM counter, adjust the first dynamic duty cycle according to the morphing frequency and adjust the second dynamic duty cycle according to a non-linear relationship with the first dynamic duty cycle.

2. The full bridge converter-circuit according to claim 1, wherein the control circuit is configured modulate the pulse patterns by using an up-down counter and triangle modulation.

3. The full bridge converter-circuit according to claim 2, wherein the pulse patterns are determined according to a value of the up-down counter and two references values corresponding to the two half bridges respectively.

4. The full bridge converter-circuit according to claim 1, wherein in the third transition mode, a fist dynamic pulse length corresponding to a first switch of the first half bridge is determined according to the first dynamic duty cycle, and a second dynamic pulse length corresponding to a second switch of the second half bridge is determined according to the second dynamic duty cycle.

5. The full bridge converter-circuit according to claim 4, wherein the control circuit is further configured to, in the third transition mode, adjust the first dynamic duty cycle and the second dynamic duty cycle such that operations of the second switch of the second half bridge and a third switch of the first half bridge is changed between the first duty cycle in the first operation mode and second duty cycle in the second operation mode.

6. The full bridge converter-circuit according to claim 1, wherein the control unit is configured to adjust the first dynamic duty cycle such that the first dynamic pulse length is changed linearly, and determine the second dynamic duty cycle according to the first dynamic duty cycle and the non-linear relationship.

7. The full bridge converter-circuit according to claim 6, wherein the non-linear relationship of the first dynamic duty cycle and the second dynamic duty cycle is a non-linear function graph predetermined according to parameters of the resonant tank and desired magnetizing current.

8. The full bridge converter-circuit according to claim 7, wherein the predetermined non-linear function graph is stored in a memory unit in the form of a look up table or discrete mapping values.

9. The full bridge converter-circuit according to claim 1, wherein the first operation mode is a full bridge modulation in which all switches of the two half bridges are turned on with the first duty cycle in every first pulse period, and the second operation mode is a frequency-multiplied half bridge modulation in which one switch of each half bridge is turn on with the second duty cycle in every second pulse period and the other switch of each half bridge is turn on in remaining duty cycle in every second pulse period, and the two half bridges has a phase delay of half the second pulse period.

10. The full bridge converter-circuit according to claim 9, wherein the first duty cycle is 50% and the second duty cycle is 25%, and the second pulse period is twice of the first pulse period.

11. The full bridge converter-circuit according to claim 6, wherein the second switching frequency of the second operation mode is half an operating frequency of the H bridge.

12. A converting method for a full bridge converter-circuit, where the full bridge converter-circuit includes a control circuit, a resonant tank and an H bridge having two half bridges and each of the half bridges comprises a pair of switches; and the converting method comprising:
operating, by the control circuit, the H-bridge in one of a first operation mode, a second operation mode, and a third transition mode between the first operation mode and the second operation mode, wherein the first operation mode is operated with a first switching frequency, a first duty cycle, and a first switching period, the second operation mode is operated with a second switching frequency, a second duty cycle and a second switching period, and the third transition mode is operated with a first dynamic duty cycle for a first half bridge, a second dynamic duty cycle for a second half bridges and a morphing frequency varying gradually between the first switching frequency and the second switching frequency;
in the third transition mode by the control circuit, determining pulse patterns of the H bridge according to a PWM counter, adjusting the first dynamic duty cycle according to the morphing frequency and adjusting the second dynamic duty cycle according to a non-linear relationship with the first dynamic duty cycle.

13. The converting method according to claim 12, wherein the pulse patterns are modulated through the control circuit by using an up-down counter and triangle modulation.

14. The converting method according to claim 13, wherein the pulse patterns are determined according to a value of the up-down counter and two references values corresponding to the two half bridges respectively.

15. The converting method according to claim 12, wherein in the third transition mode, a fist dynamic pulse length corresponding to a first switch of the first half bridge is determined according to the first dynamic duty cycle, and a second dynamic pulse length corresponding to a second switch of the second half bridge is determined according to the second dynamic duty cycle.

16. The converting method according to claim 15, wherein the converting method further includes:
in the third transition mode by the control circuit, adjusting the first dynamic duty cycle and the second dynamic duty cycle such that operations of the second switch of the second half bridge and a third switch of the first half bridge is changed between the first duty cycle in the first operation mode and second duty cycle in the second operation mode.

17. The converting method according to claim 12, wherein the adjusting the first dynamic duty cycle according to the morphing frequency and adjusting the second dynamic duty cycle according to the non-linear relationship with the first dynamic duty cycle includes:
adjusting the first dynamic duty cycle such that the first dynamic pulse length is changed linearly, and
determining the second dynamic duty cycle according to the first dynamic duty cycle and the non-linear relationship.

18. The converting method according to claim 17, wherein the non-linear relationship of the first dynamic duty cycle and the second dynamic duty cycle is a non-linear function graph predetermined according to parameters of the resonant tank and desired magnetizing current; and
wherein the predetermined non-linear function graph is stored in a memory unit in the form of a look up table or discrete mapping values.

19. The converting method according to claim 12, wherein the first operation mode is a full bridge modulation in which all switches of the two half bridges are turned on with the first duty cycle in every first pulse period, and the second operation mode is a frequency-multiplied half bridge modulation in which one switch of each half bridge is turn on with the second duty cycle in every second pulse period and the other switch of each half bridge is turn on in remaining duty cycle in every second pulse period, and the two half bridges has a phase delay of half the second pulse period;
wherein the first duty cycle is 50% and the second duty cycle is 25%, and the second pulse period is twice of the first pulse period.

20. The converting method according to claim 17, wherein the second switching frequency of the second operation mode is half an operating frequency of the H bridge.
